(19) United States
(12) Patent Application Publication
(10) Pub. No.: US 2008/0259155 A1
(43) Pub. Date: Oct. 23, 2008

(54) Online Video Operator Management System

(76) Inventors: Tom McLelland, Clovis, CA (US); Paul Taggart, Clovis, CA (US); Jackson Rollins, Provo, UT (US); Peter Ehat, Lehi, UT (US); Krishna Krishnamaneni, Fresno, CA (US); Lorin Brown, Clovis, CA (US)

Correspondence Address: KIRTON AND MCCONKIE, 60 EAST SOUTH TEMPLE,, SUITE 1800, SALT LAKE CITY, UT, 84111, US

(21) Appl. No.: 11/738,354

(22) Filed: Apr. 20, 2007

(51) Int. Cl. H04N 7/14

(52) U.S. Cl. 348/14.03; 348/E07.04

(57) ABSTRACT

The present invention relates to systems and methods for communicating with various people from remote locations, and more particularly to assisting customers through online commercial transactions utilizing a mix of live and pre-recorded video presentations and interactions. Various embodiments of the invention comprise: a) a customer connected to a network by a customer interface; b) an operator connected to a network by an operator interface; c) at least one display window in the customer interface, wherein said display window displays an object selected from a list consisting of: a live video feed of operator and a pre-recorded video clip of an operator; d) at least one interaction between said customer and said operator, wherein the interaction may be selected from a list consisting of: live text chat, live video conference, pre-recorded video messages, third party intervention, and changing the appearance of the customer interface; e) a recording device for recording customer behaviors and customer interactions with operator; f) data storage for retention of said customer behaviors and said customer interactions with operator; and g) recall device for playing at least one prerecorded video clip selected by an operator for said customer, wherein said clip is selected from a list consisting of: a prerecorded video clip of an answer to a frequently asked question, a greeting previously recorded by the operator, an answer previously recorded by said operator and an answer previously recorded by a third party.

### BACKGROUND OF THE INVENTION

1. Field of the Invention

The present invention relates to systems and methods for communicating with various people from remote locations, and more particularly to assisting customers through online commercial transactions utilizing a mix of live and pre-recorded video presentations and interactions.

2. Background and Related Art

The Internet has proven to be fertile ground for commercial and retail sales. Unfortunately, providing adequate customer support in an online retail environment remains problematic. Most on-line retailers support their WebPages with at least some form of customer support. For example, various pages utilize discussion boards, reviews or online operators to assist customers with various questions or concerns. However, difficulty acquiring adequate and timely information continues to result in decreased sales opportunities.

Certain retail business providers have discovered innovative ways to sell their products, by allowing previous purchasers of products to participate in discussion boards and leave reviews on the product. This has greatly enhanced the Internet retail environment. However, creating an effective customer/business interaction remains an obstacle, which limits retailers' capacity to interact with customers personally. In order to contact on-line businesses, a customer must call the customer service line and wait while they are transferred to someone who will be able to assist them. Importantly, on-line retailers do not have a simple way for assisting customers through Internet retail checkout.

Some, online retailers have begun to use operators who can communicate with a customer in a display window in the customer interface, such as a chat box. Throughout the shopping experience, the customer is able to ask questions and maintain a dialogue with an operator who works for the particular online retailer. While this is effective and helpful for the customer, it is inefficient and expensive for the business to have one operator working with one customer. Accordingly, there is a need in the online retail market for technology, which may be utilized to efficiently support customers through the online shopping experience.

### BRIEF SUMMARY OF THE INVENTION

The present invention relates to various methods for communicating with individuals in an online or video environment. In particular, the present invention relates to assisting individuals through checkout customer service or sales in an online retail environment. Preferred embodiments comprise: a) a customer connected to a network by a customer interface; b) an operator connected to a network by an operator interface; c) at least one display window in the customer interface, wherein said display window displays an object selected from a list consisting of: a live audiovisual feed of operator and a pre-recorded audiovisual clip of an operator; d) at least one interaction between said customer and said operator, wherein the interaction may be selected from a list consisting of: live text chat, live video conference, pre-recorded audiovisual messages, third party intervention, and changing the appearance of the customer interface; e) a recording device for recording customer behaviors and customer interactions with operator; f) data storage for retention of said customer behaviors and said customer interactions with operator; and g) recall device for playing at least one prerecorded audiovisual clip selected by an operator for said customer, wherein said clip is selected from a list consisting of: a pre-recorded audiovisual clip of an answer to a frequently asked question, a greeting previously recorded by the operator, an answer previously recorded by said operator and an answer previously recorded by a third party.

Some embodiments comprise methods for allowing an operator to initially interface with a consumer who is beginning to browse a particular site, methods for allowing an operator to answer frequently asked questions, methods for allowing third parties to participate with the operator and consumer, and methods for allowing the audio feed between the operator and the consumer to be printed as text in a window on a display screen.

Some embodiments allow the operator to utilize pre-recorded audio and/or video answers during the consumers shopping experience as a method of communicating information about a particular product, assisting the consumer and/or completing a sale.

In some embodiments, certain events (e.g., too many digits in a credit card number, incorrect format on an email address, etc.) trigger an operator to assist a consumer during the checkout process.

In some embodiments, the IP address of a consumer may be retained, wherein the shopping behaviors and the interaction between the consumer and the operator may be tracked to allow operators to assist the consumer based on prior shopping and purchasing habits.

In some embodiments, various forms, types and levels of information may be captured automatically, as initiated by an operator/supervisor or as triggered by discrete pre-determined events, may be captured and may be subsequently or contemporaneously utilized or processed. Non-limiting examples of the types of information that may be captured/processed comprise information about previous websites visited by a user before visiting a site of interest, geographical location of the user, etc.

Some embodiments comprise storing large amounts of information about the consumer in a database, which is accessible to an operator or a third party assisting the consumer through the shopping experience.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an embodiment of an operating environment suitable for implementing some embodiments of the invention;

FIG. 2 shows an operator interacting with at least two customers according to some embodiments of the present invention;

FIG. 3 shows an exemplary flow chart of the steps that occur as a consumer browses a webpage according to some embodiments of the present invention;

FIG. 4 is a flow diagram which shows selected features of the frequently asked questions function according to some embodiments of the present invention; and

FIGS. 5 A-L are a series of screenshots which show selected features according to preferred embodiments of the present invention.

### DETAILED DESCRIPTION OF THE INVENTION

A description of the embodiments of the present invention will now be given with reference to the Figures. It is expected that the present invention may take many other forms and shapes, hence the following disclosure is intended to be illustrative and not limiting, and the scope of the invention should be determined by reference to the appended claims.

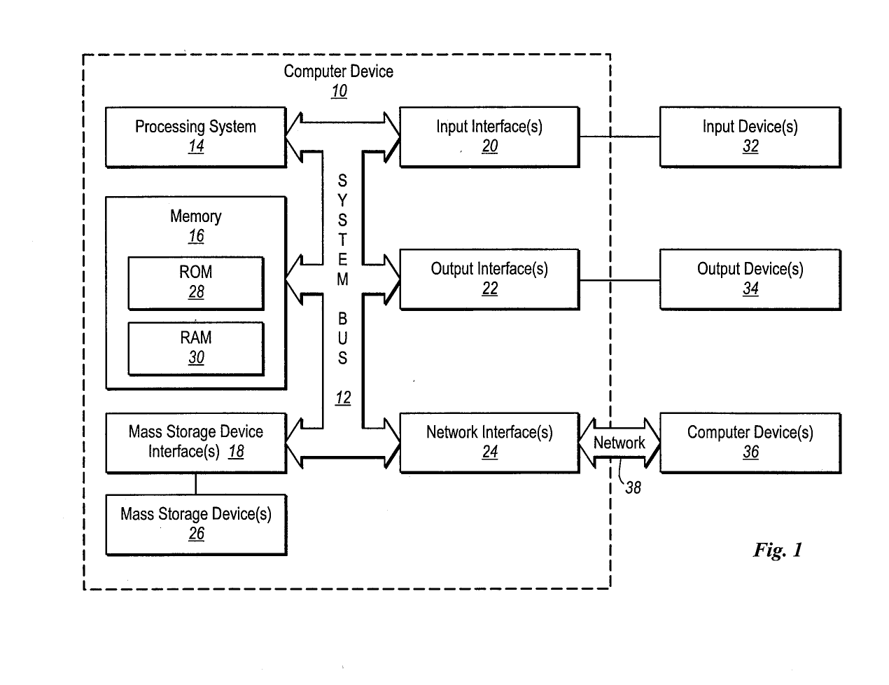

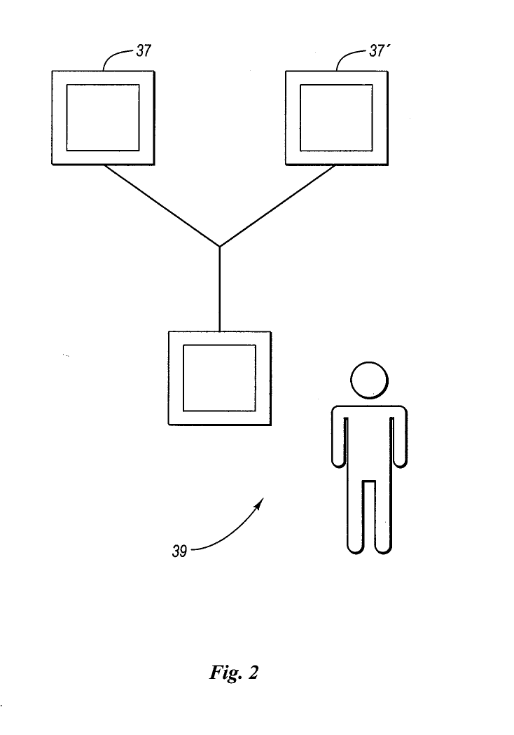

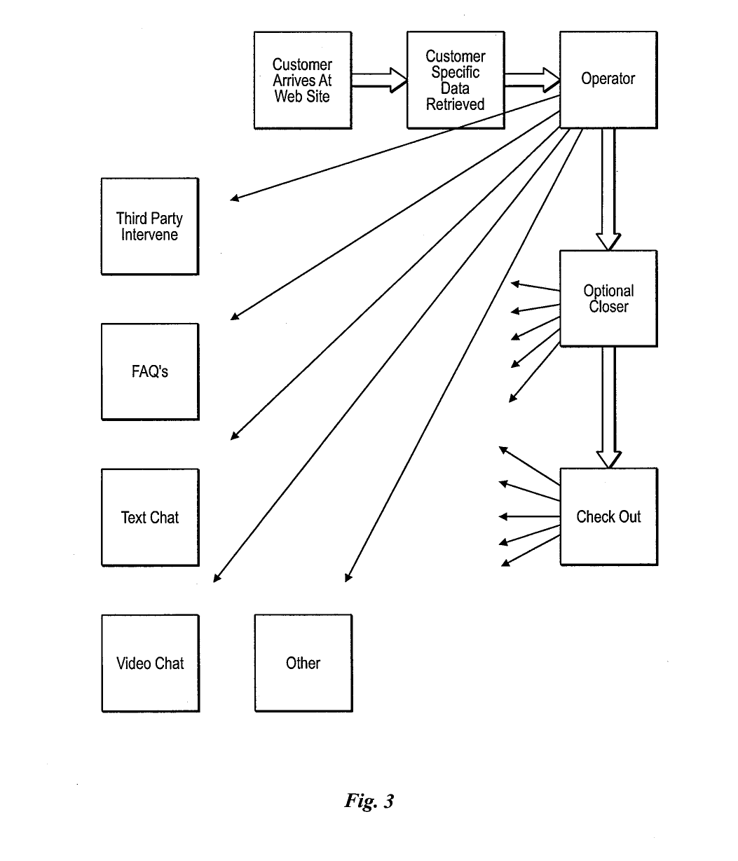

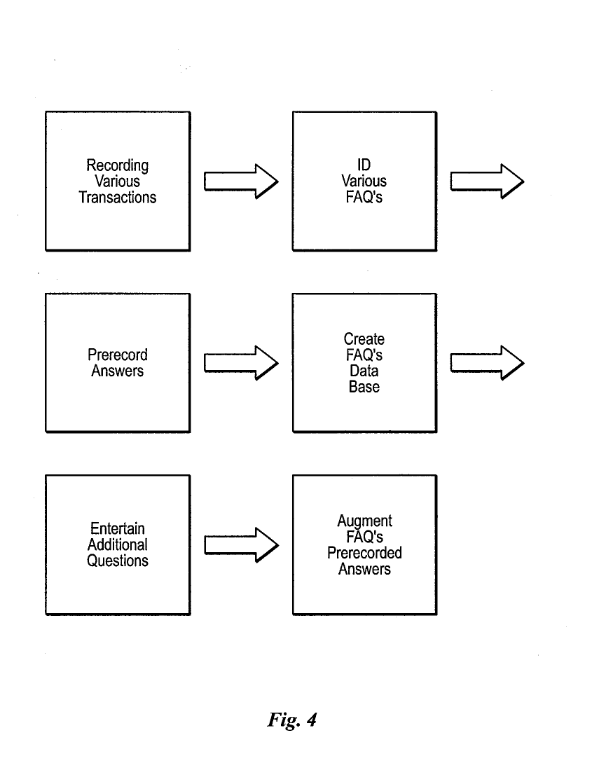

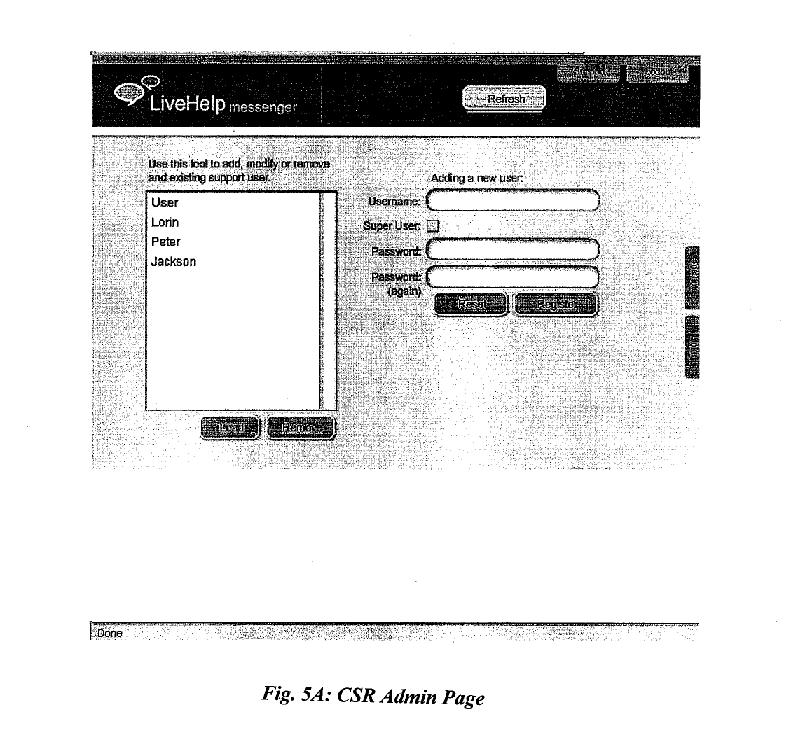

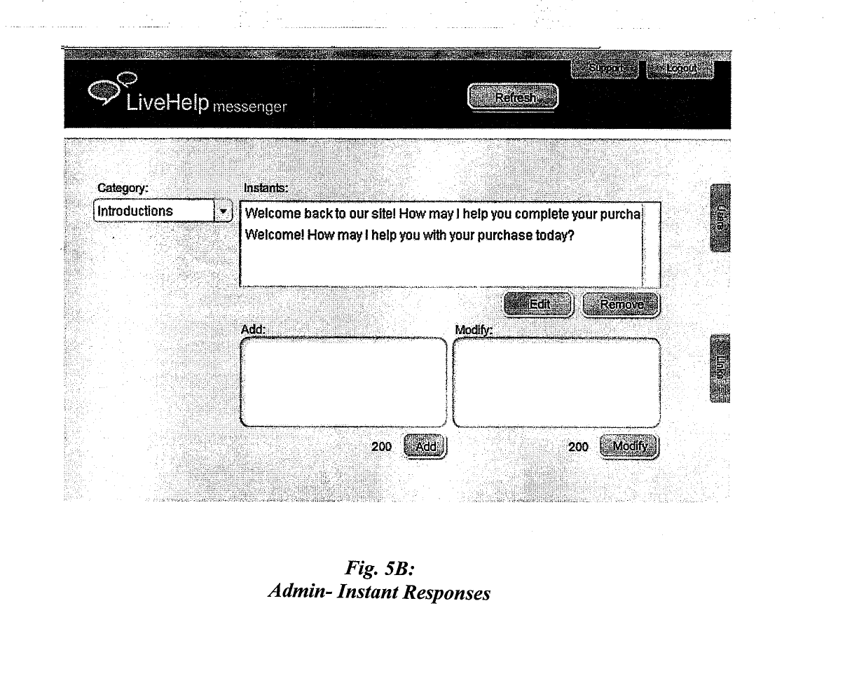

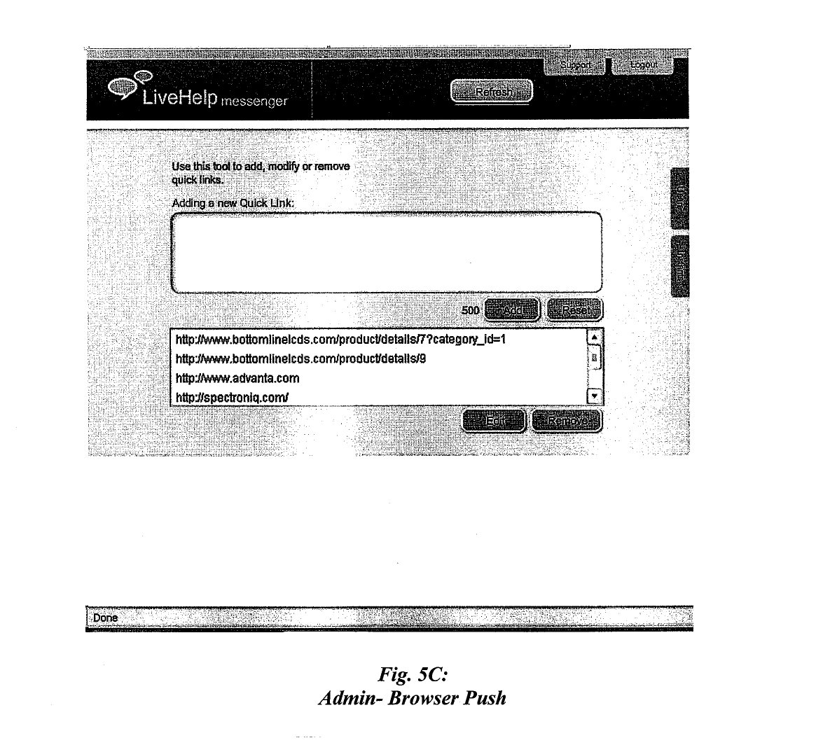

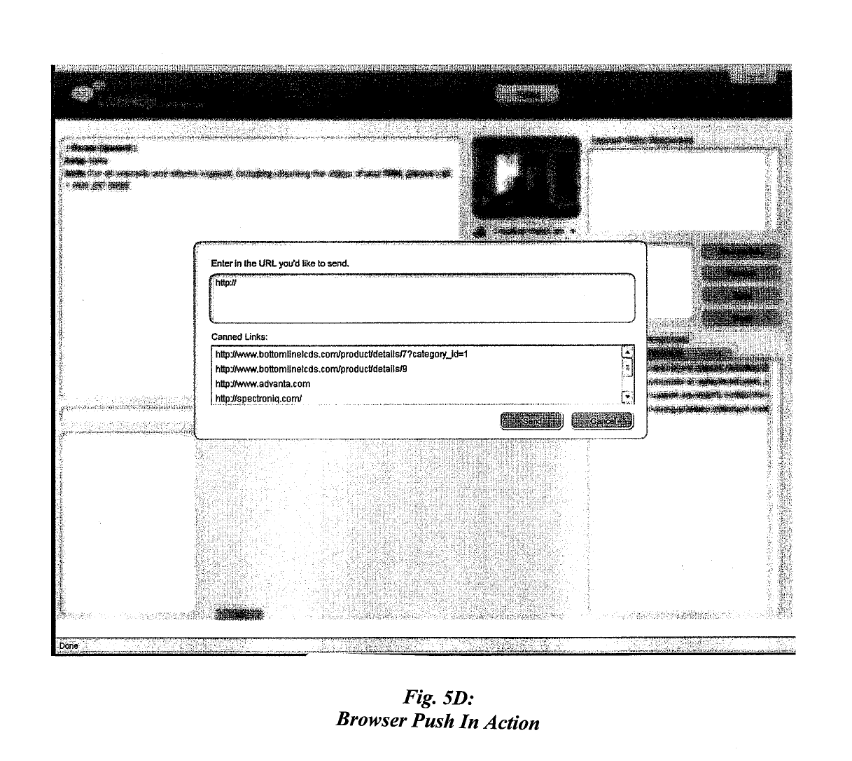

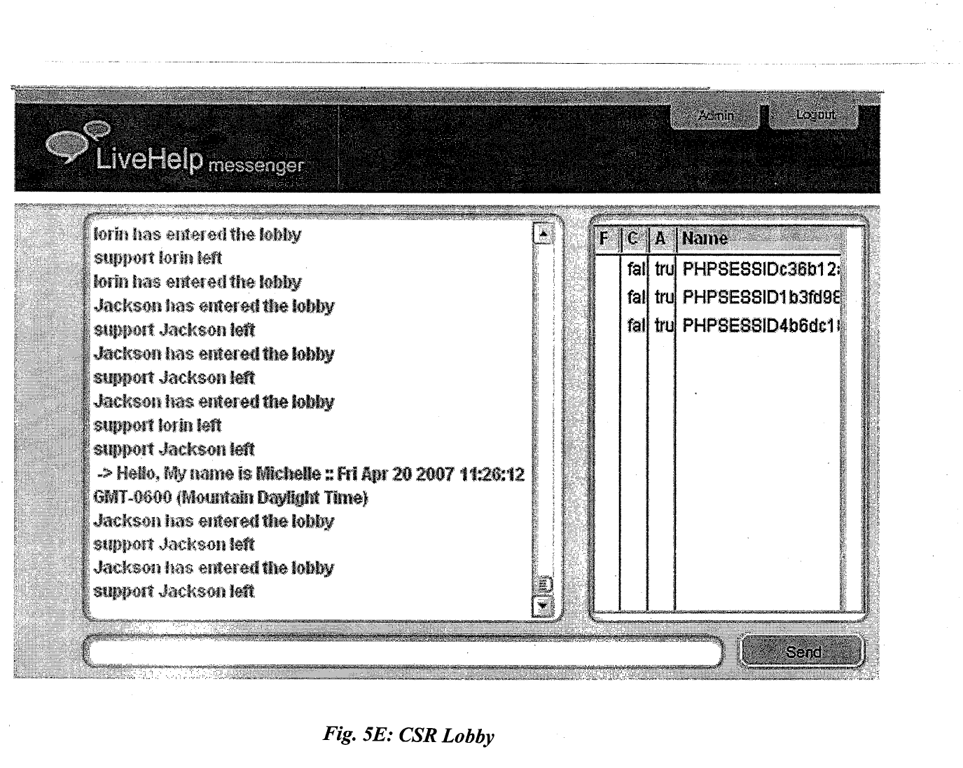

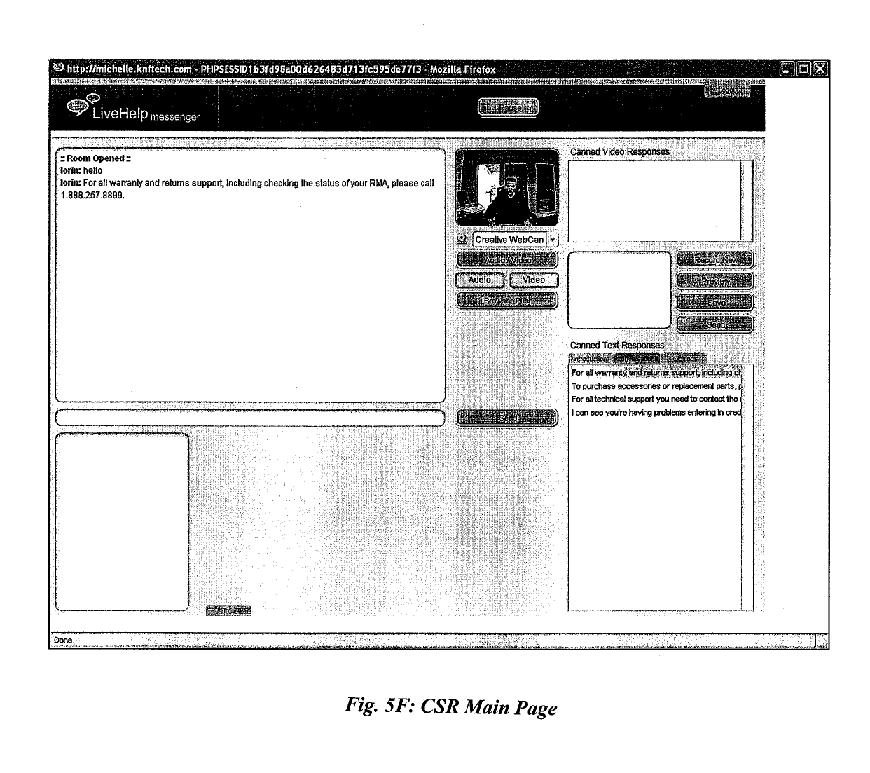

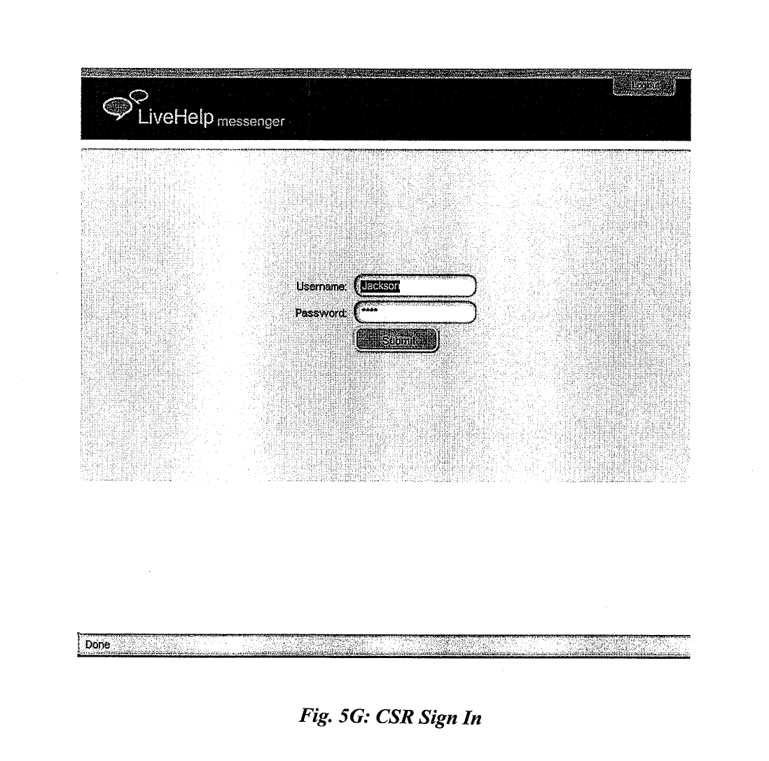

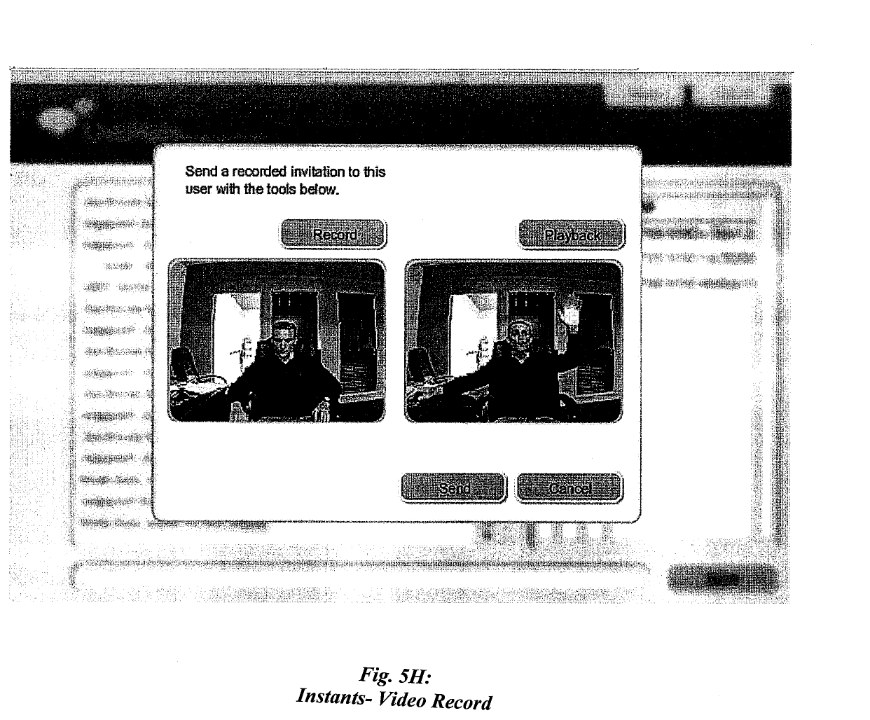

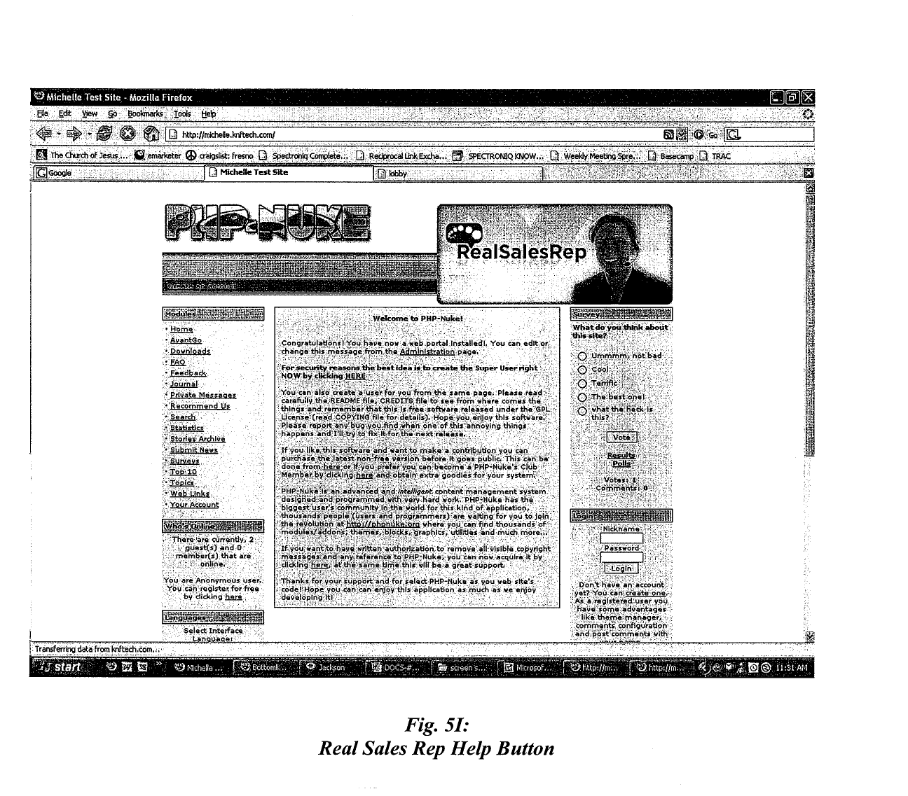

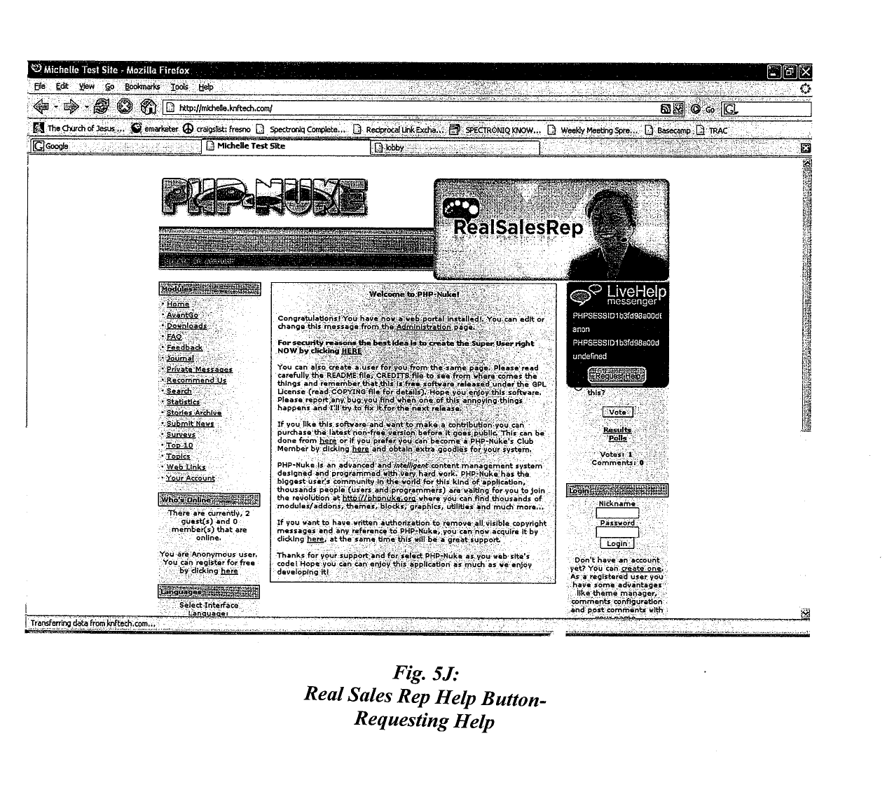

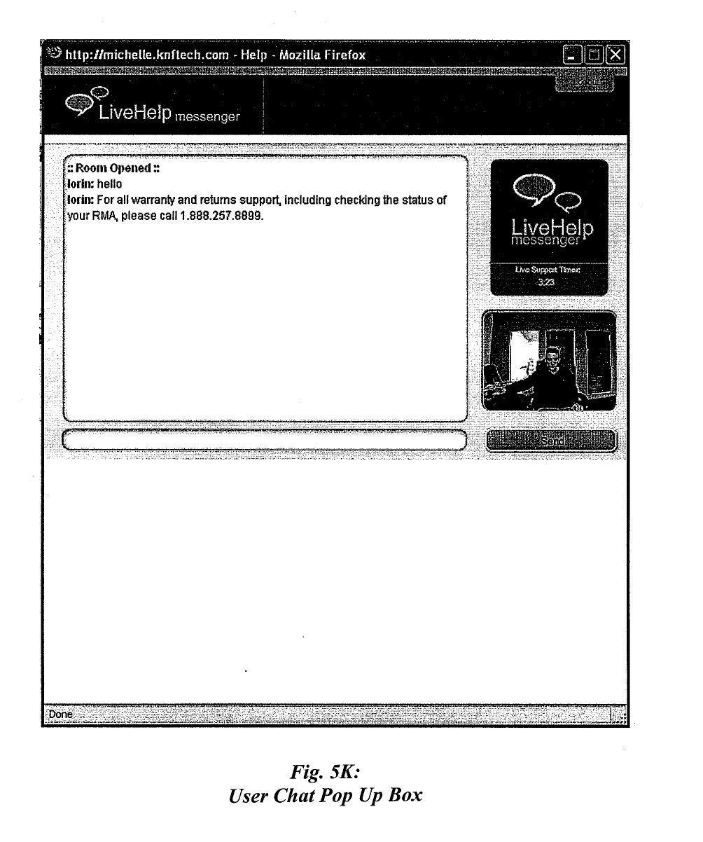

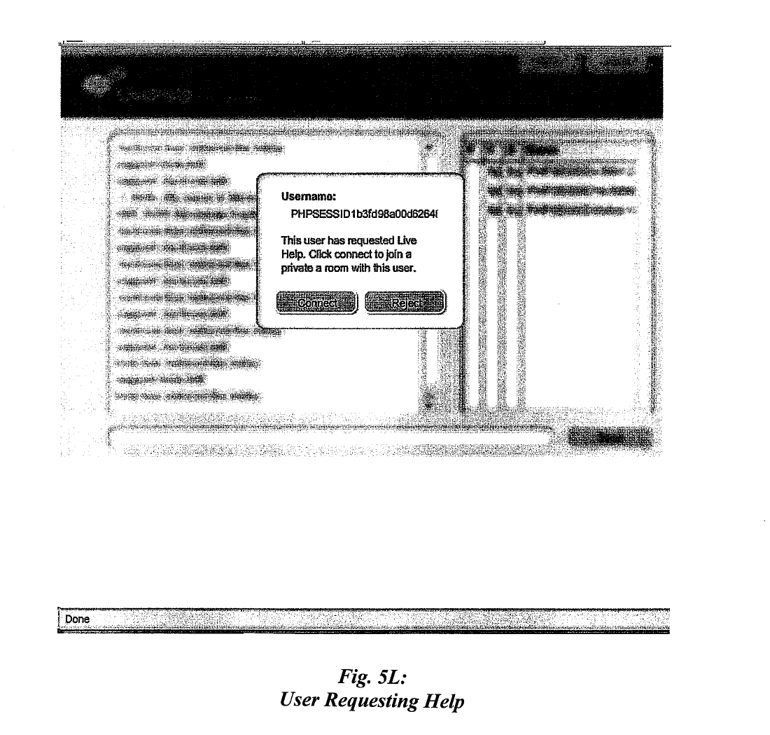

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

While those skilled in the art will appreciate that the invention may be practiced in networked computing environments with many types of computer system configurations, FIG. 2 represents an embodiment of the present invention in a networked environment that includes clients connected to a server via a network. While FIG. 2 illustrates an embodiment that includes two clients connected to the network, alternative embodiments include one client connected to a network or many clients connected to a network. Moreover, some embodiments, in accordance with the present invention, may also include a multitude of clients throughout the world connected to a network, where the network is a wide area network, such as the Internet.

As previously indicated, FIG. 2 illustrates two clients/customers 37 connected via a network to the internet, in accordance with some embodiments of the present invention. In some embodiments, a customer 37 may begin browsing a website of choice. While browsing the website, the customer may be assisted by an operator 39. In preferred embodiments the operator 39 may appear as an object 43 on a customer interface device (e.g., a home computer, laptop, PDA, etc.). In preferred embodiments, the operator 39 appears as a small pop-up video frame 43 visible to the customers 37, supplemental to the information already displayed on the webpage accessed by the client. The operator 39 interaction with the client 37 may comprise live or pre-recorded audiovisual segments. For example, the operator 39 may initially y greet the consumer, and indicate that he/she will be available to answer any questions the consumer may have during the shopping experience. In some embodiments, the operator 39 may push information to the client 37.

Preferred embodiments comprise error reporting and flagging technology. For example, some embodiments comprise programming and/or coding to determine when a customer has entered wrong information into an HTML form with exact details of the error. When information is entered incorrectly a customer service representative may be notified. In preferred embodiments, the operator 39 may address the error by corresponding live (e.g., video conferencing, text chat, etc), or via prerecorded messages (e.g., pre-recorded audio, pre-recorded video, pre-recorded audiovisual material, etc.) with the client 37.

According to some embodiments, when a client 37 begins browsing, an audio noise may be utilized to acquire the clients' attention and an operator 39 may be notified that a client 37 has connected to a particular site. In some embodiments, the notified operator has several options for proceeding. In preferred embodiments, the operator can wait until the client pushes a button requesting to talk to the operator, or the operator may engage the client immediately. If the operator chooses to engage the client immediately, or if the operator has been requested, a window 43 may pop-up on the screen and live or recorded video of the operator appears in which the operator may greet the client and/or answer their question. For example, after a client 37 has entered a website live or recorded, video of the operator may be presented as a supplemental object 43 on the page, “Hi, I am Michelle, welcome to our webpage. If you have any questions I am happy to help you.” In some embodiments, the window 43 may stay open or may be minimized to facilitate optimal browser configurations or user 37/39 preferences.

In preferred embodiments, the operator 39 interaction with the client 37 may be supported by a series of pre-recorded responses, answers and dialogues which may be permanently recorded, recorded intermittently or recorded on a daily basis. For example, an operator 39 may record several preset greetings when the operator first arrives at the office in the morning. The preset greetings may be later accessed at convenient points during the shopping process to assist the operator 39 in managing multiple clients 37 through the shopping experience. For example, one prerecorded greeting may indicate “welcome to our website, if you have any questions I am here to help.” Another recording may indicate “I will be right back with you.” Accordingly, situations that frequently occur during the shopping process may be addressed by a small subset of prerecorded answers, questions, comments and/or greetings. Since the live and recorded video segments are indistinguishable, the customer has the perception that an operator is giving the customer full time attention. The operator may handle several conversations at once by playing the appropriate recorded responses to questions.

In preferred embodiments, an operator 39 may utilize the set of prerecorded messages to manage the shopping experience of multiple clients as indicated in FIG. 2. The operator 39 may simply push a button and the prerecorded video clips will be displayed to the consumer 37 who will experience the clip as a live audio feed, even though the operator 39 may be presently helping another customer 39 through their shopping experience. Accordingly, in preferred embodiments the operator 39 has the capacity assist several customers 37 simultaneous, wherein each assisted customer 37 experiences the assistance as a live one-on-one interaction.

Some embodiments comprise a prerecorded component and a live component. For example, each client 37 may be initially greeted live by an operator 39. Subsequently, the client 37 may be exposed to one or more prerecorded audiovisual messages. Interspersed between the presentation of prerecorded messages, an operator 39 and client 37 may conduct live discussions. For example, the live discussions may be video conferencing, live text chatting, etc. For example, if a client, resident on a homepage for a website selling flat screen monitors, first greeted by an operator with a prerecorded video clip (e.g., “Hi I am here and happy to help”), then asks a question by typing text into a chat box to the operator 39, (e.g., “I have questions about a different thirty-two inch monitor screen,”) then, various embodiments may provide face to face live chat with the client or to allow an operator to push a prerecorded message to the consumer. Ultimately, in preferred embodiments, the consumer engages in a conversation with the live and prerecorded components of the present invention without distinguishing which segments are live and which are prerecorded.

In some embodiments, the operator 39 may interact with the operator interface 50, on the operator side, which changes the client interface 48 display. The client/operator/supervisor interface 48, 50, 52 may be any device which allows communication between the various parties to the interaction. In preferred embodiments the interface may be a computer, a phone and/or a PDA. For example, the operator 39 may initiate the transfer of the client 37 from the home page to a particular product page containing thirty two inch monitor screens.

In addition to allowing an operator 39 to manipulate the client interface 48, the operator 39 may have the option to add comments, questions or initiate a sale. For example, the operator may indicate, “by the way, you do know that we have twelve months same as cash financing on the thirty-two inch purchase today?” Or, in another example, the operator may indicate “my manager has told me that we can offer a free extended warranty for all those that purchase by 12:00 p.m. today.” The consumers 37 may also chat (e.g., text messaging, video conferencing, etc.) with the operator if they have additional questions.

In some embodiments, the operator can involve third parties 41 to assist the operator and the client through the shopping experience. In some embodiments, multiple parties may interact with a consumer. For example, the client may work with the operator, a supervisor, a third party tech consultant, a warranty rep and/or any other entities who may be utilized to assist the client in acquiring information or deciding whether to purchase a particular item. In one example, the operator 39 may introduce his/her supervisor 41. A pop up video screen of the supervisor 41 may become visible to the consumer 37 allowing the consumer 37 to interact directly with the supervisor 41 and/or with the operator 39.

In some embodiments, the supervisor 41 or other the third party 41 may intervene in an interaction already occurring between an operator 39 and a client 37. Accordingly, if a supervisor 41 monitoring a particular client/operator 37, 39 interaction decides that some additional information may be helpful, or may drive a sale, a supervisor 41 may intervene into the conversation. According to some embodiments, audio noise and/or visual notification may accompany a pop up audiovisual window which appears on the client and operator browser 48, 50. The intervening party 41 may interact by with the operator 39 and the client 37, or the intervening party 41 may utilize pre-recorded clips, which may be played to the client 37 and/or operator 39 to assist during important steps in the purchasing process.

In some embodiments, once at checkout, the operator 39 may pass the client to another party 46 to close the transaction. The closer 46 may interact with the client 37 either utilizing live chat or prerecorded video clips. For example, the closer 46 may introduce herself with a pre-recorded video clip. In some embodiments, the closer may initiate a dialogue with a client to assist the client through the critical steps of finalizing the transaction.

In some embodiments, an operator 39 or closer 46 may be working with several different customers 37 simultaneously. For example, one operator 39 may work with up to fifty or more clients 37. Because, in accordance with some embodiments, the operator 39 merely introduces himself/herself with a prerecorded video clip, the operator 39, may in live time, actually be assisting another client 37 with a live video chat option, and yet another client 37 with a distinct pre-recorded audiovisual message, and yet another client 37 with a live text chat option. Accordingly each consumer 37 may be presented with the perception that an operator 39a is dedicated to assisting that particular consumer 37 for the entire shopping experience via a one-on-one setting, while the operator 39 is simultaneously assisting multiple customers 37 through the shopping experience. For example, one consumer 37 may have just logged onto the webpage and be browsing while another consumer 37 may have already filled a shopping basket and be ready to be transferred to a closer 46. In this example, the operator may press a first button, which plays a pre-recorded clip for the first customer which indicates “it appears that you are browsing for flat screen monitors, can I give you assistance in selecting a particular model?” And, within seconds press a button which introduces the closer 46 to the second customer 37. Accordingly, in preferred embodiments one operator 39 has an increased capacity to interact with multiple clients 37 simultaneously, and to communicate to each of the clients 37 that an operator 39 is live, waiting and assisting them on a one-on-one basis through the entire shopping experience. By mapping the path the customer has taken and displaying it every time live convseration is requested, the operator can keep track of where they left off in the conversation.

In some embodiments, the entire transaction history associated with a particular IP address and/or customer 37 may be recorded. For example, if a particular customer visited a website and did not purchase an item and then subsequently returned to the website, the tracked IP address/customer identification would trigger the recorded history for the IP address/particular customer which may include the consumer's browsing, purchasing and operator interaction history. The history may be instantly available to the operator 39 assisting the client at the webpage on their subsequent visit.

According to some embodiments, when a client 37 visits a site, a query is performed to determine whether the client 37 has ever visited the site before. If they have, instantly all of the data relating to the client's history is loaded into a window, visible to the operator 39. In some embodiments the operator 39, may mine down into the data set, acquiring additional supplemental data related to the client's history. The operator 39 may have the capacity to acquire information, not only about what the client has purchased, but what conversations were previously held between with the client 37, other operators 39 and/or other third parties 41. Continuing the example utilized above, if the consumer 37, who had previously been looking for a thirty-two inch screen failed to purchase and then returns, a new operator 39 working with the client would have access to this information. Using the referenced information, the operator 39 may modify the way in which the operator 39 interacts with the prospective customer 37. For example, if the same customer 37 has returned to the site multiple times, and looked at the same screens, the operator 39 may deduce that the customer 37 is price sensitive and may offer a price break to close the sale. Alternatively, the new operator 39 may simply engage the customer 37 with a prerecorded greeting “oh, I see you've been here before and were looking at the 32 inch screen. What can I do to help you make a purchase today?” Accordingly, the new operator 39 has various options for proceeding.

Additionally, third parties 41 may choose to intervene, or the operator 39 may choose to integrate a third party 41 into the discussion in an effort to close a sale or to provide information for the consumer 37. For example, an operator 39 working with a repeat customer 37 may introduce herself as indicated above and then indicate: “Please allow me to ask my manager if we can get a better price on that thirty-two inch flat screen for you today; you have been here a couple of time before, so you are obviously serious.” Accordingly, various sales techniques may be integrated into the online shopping experience, which may be utilized to improve the shopping experience, provide information to a consumer or increase the rate of sales experienced at a particular website.

The third party 41 may be resident anywhere in the world and the supervisor or manager 41 can be watching thousands or tens of thousands of operators 39 at any one time on the manager's interface device 52. According to some embodiments, the manager may insert a video image of himself next to the video image of the operator on the client's browser 48 introducing himself to the client 37. For example, the manager 41 may indicate “our operator just asked if you could get a better deal on the thirty-two inch screen today?” In some embodiments, a consumer 37 may be presented with the perception, that the consumer 37 is being handled simultaneously by a live operator 39 and by a live manager 41. For example, the consumer 37 has the option to live chat with the operator 39 and live chat with the manager 41, contemporaneously. Alternatively, the supervisor 41, the operator 39 or the customer 37 may terminate any one of the connections so that the client 37 is capable of talking with only one of the operator 39 and supervisor 41. Further, the operator 39 and supervisor 41 may correspond in real time with one another about the customer's purchasing behavior without the customer 37 being aware of their interaction.

In some embodiments, video cameras, web cameras or similar technologies may be utilized to facilitate video to video conferencing. Accordingly, an operator 39 may have access to a live video feed of a customer 37 and/or other third parties 41 (e.g., a supervisor). And, likewise the supervisor 41 and/or the consumer 37 may, as previously noted, receive a live video feed of the operator 39 and/or the manager 41. In some embodiments the manager 41 may actually conduct a video to video conference with the operator 39 and/or the customer 37. These live video to video, face to face conversations may be augmented by prerecorded fillable audiovisual, audio, and/or written material. For example, if a parent 37 is interested in having their child interviewed by a prominent psychologist 39 or foremost authority on attention deficit disorder, but live several hours away, the present technology may be utilized to conduct a live face to face conversation between the parent 37, child and the authority 39.

Some embodiments may comprise the additional feature of converting audio, spoken by any of the parties involved, into text which may be displayed in a chat window associated with the particular speaker. For example, if an operator 39 greets an individual 37 as they enter a particular website, the pre-recorded video clip will be presented with the additional feature that the audio portion of the clip will be available for viewing as text below the operator's video image. Accordingly, the present application may be utilized by persons with disabilities and/or the technology may be utilized to synthesize various elements of the audio conversation being conducted between parties to the system.

Some embodiments comprise platforms which may be utilized by various portable devices. For example, a user may access the present system from a telephone or PDA. All of the features of the present invention may be routed through such remote processing devices. The present invention may be utilized in various settings. For example, the technology may be utilized in a counseling setting, a training setting, in medical applications, in commercial and retail environments or in educational settings.

In some embodiments, a color coding system may be utilized to assist an operator 39 and/or a supervisor 41 in managing the multiple clients/operators for which they are responsible. In some embodiments, color codes may be used to show the progress of the person through the purchasing process. For example, persons 37 highlighted in green may have received an introduction and have barely begun browsing. Persons 37 highlighted in yellow may have items in their basket and persons 37 highlighted in red may be in the checkout phase. Various additional color coding schemes may be utilized to identify particular characteristics associated with clients 37. For example, the color purple may be associated with clients 37 who are return non-purchasing customers 37, while blue be utilized in association with clients 37 who may have previously purchased from a given website. Accordingly, an operator 39 present in front of a computer screen may be exposed to several small browsers each of which contain color coded information related to the various customers 37.

As previously indicated, in some embodiments a database storage function may be utilized. In particular the browsing purchasing behaviors and interactions with the operators may be temporarily or permanently recorded to a database. Database information may be retrieved on demand or at any time the customer 37 returns to a supported webpage.

In addition to tracking a particular user's behavior, all of the interactions between clients 37 and operators 39 (e.g., video conferencing, text messaging, answer question sessions between client 37 and operator 39, etc.) may be collected and stored centrally.

A manager or supervisor 41 may utilize recorded data as a basis for developing improving client 37 operator 39 interactions. For example, a supervisor 41 may produce an answer set. The answer sets may be incorporated into an archive of frequently asked questions and associated video clip answers, or the answers may be incorporated into the pre-recorded messages created by an operator 39 on a daily basis. In other embodiments, the information may simply be passed to operators 39 and utilized as a basis for providing correct answers to customers 37 in live chat sessions. For example, a supervisor 41 who has reviewed the stored data set may note that nearly all customers 37 have basic questions about the warranties offered on various items. According to some embodiments, the supervisor 41 may record a video clip which provides information referring to the frequently asked question and save the same to a database which is accessible by operators 39, other supervisors 41 and/or clients 37. In this example, once a client 37 asks a frequently asked question, an operator 39 and/or a supervisor 41 may push a button associated with the particular frequently asked question, which in turn plays the previously recorded video clip containing an answer to the frequently asked question for the consumer 37. In some embodiments, operators 37 may conduct live chat sessions after playing the pre-recorded video clip, as a means of following up with a consumer 37 to ensure that all of the consumers questions and concerns have been addressed.

In some embodiments, operators 37 may have the capacity to access a database to search all of the questions and answers, which have a particular term associated with them. The operator 39 may then respond by answering the questions verbally in a live video chat session with the consumers, type the answer to the consumer 37 in a chat session, or push another video onto the screen which provides information in a pre-recorded format for the consumer 37. Accordingly, the operator 39 may provide information to clients in various formats and has the capacity to manage multiple clients with multiple queries simultaneously.

In some embodiments the database may act as a training tool for operators allowing the operator to develop a broader capacity to understand appropriate reactions to various marketing and business situations.

In some embodiments, the tracking and analytics may contain diverse data. For example, data may comprise information related to but not limited to the following: page views including data related to time per individual page, entry and exit pages, geographical information including (e.g., country, state and city codes), computer stats (e.g., desktop resolution, operating system, browser, browser version), Click stream information including upstream and downstream from a site of choice, what products a user looked at and for how long, if a user is using the sites search engine and what the queries are, complete transcripts of chat sessions including: audio, video and text, search engine keywords used to bring a user to a particular site, referring domains that ended in sales/conversions, PPC Visitor Referral Tracking, user IP address, user Internet Service Provider, and time zone information. The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A communication system comprising:
a) a customer connected to a network by a customer interface;
b) an operator connected to a network by an operator interface;
c) at least one display window in the customer interface, wherein said display window displays an object selected from a list consisting of:
a live video feed of operator and a pre-recorded video clip of an operator;
d) at least one interaction between said customer and said operator, wherein the interaction may be selected from a list consisting of:
live text chat, live video conference, pre-recorded video messages, third party intervention, and changing the appearance of the customer interface;
e) a recording device for recording customer behaviors and customer interactions with operator;
f) data storage for retention of said customer behaviors and said customer interactions with operator; and
g) recall device for playing at least one prerecorded video clip selected by an operator for said customer, wherein said clip is selected from a list consisting of:
a prerecorded video clip of an answer to a frequently asked question, a greeting previously recorded by the operator, an answer previously recorded by said operator and an answer previously recorded by a third party.

2. The system of claim 1, wherein the customer, operator interaction further comprises an element selected from a list consisting of: co-browse support, automatic error checking; and
filling out fields with a user.

3. A method for increasing sales in an internet environment comprising:
a) tracking the progress of a customer through a website;
b) monitoring the activities of the customer when the checkout portion of the website has been accessed;
c) alerting a live operator that a customer has reached the check out portion of the website; and
d) opening a window on the checkout page of the website wherein the customer sees and hears the live operator.

4. A communication system comprising:
a) a website having a computer customer graphical user interface;
b) an operator connected to the website by an operator graphical user interface;
c) at least one display window in the customer interface, wherein said display window displays an object selected from a list consisting of:
a live video feed of the operator and a pre-recorded video clip of the operator;
d) at least one form of communication between said customer and said operator, wherein the communication may be selected from a list consisting of:
live text chat, live video conference, pre-recorded video messages, third party intervention, and changing the appearance of the customer interface; and
e) mapping software for tracking prior visits to locations on the website, current location on the website and past interactions with the operator.

5. A system for simulating a live store experience on an internet website comprising:
a) providing a window on the pages of the website that shows video of a live operator;
b) providing a chat interface allowing the customer to type inquiries of the operator;
c) providing a customer interface to the operator allowing the operator to choose to respond to the inquiry from the customer by either playing a prerecorded response or answering with a live audio and video streaming response; and
d) tracking prior responses and inquiries so that the operator can communicate with customer so they perceive that they are all having a live conversation simultaneously.
